(19) United States
(12) Patent Application Publication
(10) Pub. No.: US 2023/0230094 A1
(43) Pub. Date: Jul. 20, 2023

(54) SYSTEM AND METHOD FOR ROUTING A FINANCIAL TRANSACTION TO A PAYMENT DEVICE SELECTED FROM AMONG A PLURALITY OF PAYMENT DEVICES

(71) Applicant: Percents, Inc. (dba Percents), Seattle, WA (US)

(72) Inventors: Benjamin Taylor, Seattle, WA (US); Phillip Chao, Seattle, WA (US)

(21) Appl. No.: 18/096,418

(22) Filed: Jan. 12, 2023

Related U.S. Application Data
(60) Provisional application No. 63/299,812, filed on Jan. 14, 2022.

(51) Int. Cl. G06Q 20/40; G06Q 20/34

(52) U.S. Cl. CPC G06Q 20/405; G06Q 20/351; G06Q 20/4015

(57) ABSTRACT

A financial transaction processing system for automatically routing a financial transaction to a payment device and methods for making and utilizing the same. The financial transaction processing system can include receiving information about a financial transaction initiated by a consumer or other user who is associated with two or more physical and/or digital payment devices. The financial transaction information can be routed to a selected payment device of the user based upon one or more payment device features of the payment devices, information about the financial transaction, information about the user initiating the financial transaction and/or information about at least one vendor for fulfilling the financial transaction. The financial transaction processing system advantageously can enable the user to use a single aggregating payment method for financial transactions and create underlying financial transaction authorizations corresponding to financial transaction authorizations on the top-level aggregating payment method.

### CROSS-REFERENCE TO RELATED APPLICATIONS

This application claims the benefit of, and priority to, U.S. Provisional Application Ser. No. 63/299,812, filed on Jan. 14, 2022, the disclosure of which is hereby incorporated herein by reference in its entirety and for all purposes.

### FIELD

The disclosed embodiments relate generally to the field of financial transaction processing and more particularly, but not exclusively, to systems and methods for automatically routing authorizations to different underlying payment methods through an aggregating payment method based on authorization details and user preferences.

### BACKGROUND

The average consumer has four credit and debit cards according to a 2021 study.

Conventional financial transaction processes require a consumer, when making a new purchase, to select a card held by the consumer and then apply the new purchase to the selected card. The selection of the card is a manual selection and is based upon several factors, such as consumer preference, interest rate, available credit limit and rewards program, for each card.

In view of the foregoing, a need exists for a system and method for automatically routing a financial transaction to a payment device selected from among a plurality of payment devices that overcome the aforementioned obstacles and deficiencies of currently-available payment devices.

### BRIEF DESCRIPTION OF THE DRAWINGS

FIG. 1A is a top level flow chart illustrating an exemplary embodiment of a method for automatically routing a financial transaction to a payment device.

FIG. 1B is a top level flow chart illustrating an exemplary alternative embodiment of the method of FIG. 1A, wherein the method includes confirming one or more attributes associated with the financial transaction.

FIG. 2 is a detail flow chart illustrating an exemplary embodiment of the method of FIGS. 1A-B, wherein a remote server receives information about the financial transaction and selects an appropriate payment device for the financial transaction based upon the received information.

FIG. 3 shows an example computer system for implementing the method of FIGS. 1A-B.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

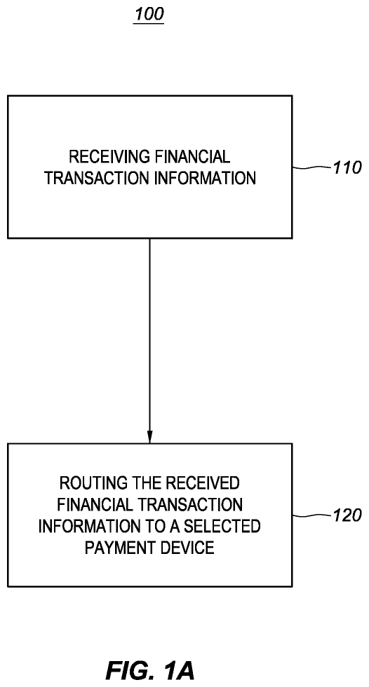

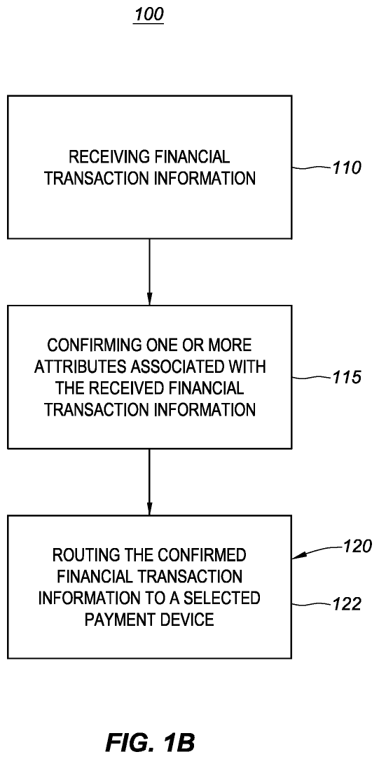

Since conventional financial transaction processes require consumers to manually select a credit or debit card and then apply a new purchase to the selected card, a financial transaction processing system and method for automatically routing a financial transaction to a payment device selected from among a plurality of payment devices can prove desirable and provide a basis for a wide range of applications, such as credit cards, debit cards and other types of physical and/or digital payment devices. This result can be achieved, according to one embodiment disclosed herein, by a financial transaction processing method 100 as illustrated in FIG. 1A.

Turning to FIG. 1A, the financial transaction processing method 100 is shown as including, at 110, receiving financial transaction information (not shown). The received financial transaction information can comprise any conventional type of financial transaction information, such as information related to a new purchase, a new purchase authorization or other type of financial transaction.

In selected embodiments, the financial transaction information can be generated based upon a financial transaction or other action initiated by a consumer or other payment device user who is associated with two or more credit cards, debit cards and other types of physical and/or digital payment devices. Exemplary payment devices can include, but are not limited to, a physical/virtual payment card, a physical/virtual credit card, a physical/virtual debit card, a cryptocurrency, a bank account, or any other suitable type of funding source.

The financial transaction information, for example, can be based upon one or more payment device features of the payment devices. Each payment device can be associated with one or more payment device features, such as an interest rate, available credit limit and/or rewards program, without limitation. The user thus may develop a user preference for one of more of the digital payment devices based upon the payment device features. Additionally and/or alternatively, the user preference can be based upon the type of financial transaction and/or current rewards program goals.

Additionally and/or alternatively, the financial transaction information can be based upon at least one financial transaction characteristic of the financial transaction initiated by the user. Exemplary financial transaction characteristics can include, but are not limited to, information about the financial transaction, the user initiating the financial transaction and/or at least one merchant or other vendor for attending to or otherwise fulfilling the financial transaction.

The financial transaction information, for example, can include information about the goods and/or services being purchased by the user as a part of the financial transaction. Exemplary information about the goods and/or services can comprise a purchase quantity, a purchase price, a description of the goods and/or services, a model number of the goods and/or services, an availability of the goods and/or services, a date and/or time of the financial transaction, a shipping and/or delivery deadline for the goods and/or services, a payment term, and/or a duration term, without limitation.

Additionally and/or alternatively, the financial transaction information can include information associated with the user and/or information associated with the vendor fulfilling the financial transaction. The user information can include information about the user personally, such as, a geographic location of the user, a time of day when the user typically initiates financial transactions, and/or a financial transaction history of the user. The vendor information can include, but is not limited to, a merchant category code of the vendor, a merchant category type of the vendor, a geographic location of the vendor, a presence (online vs. offline) of the vendor, and/or whether the user has engaged in prior financial transactions with the vendor, without limitation.

In selected embodiments, the financial transaction processing method 100 advantageously can utilize the geographic location of the vendor to determine which payment device of the user should be used for initiating the financial transaction. The payment device determination can be based, for example, upon any foreign exchange fee associated with each payment device and/or a type of currency used by the vender in view of the geographic location of the vendor. Additionally and/or alternatively, payment device determination can be based upon a rewards program associated with each payment device. One or more of the payment devices may be associated with a rewards program that offers a reward for initiating a financial transaction with a preselected vendor and/or a reward for initiating a financial transaction with a vendor associated with a preselected merchant category code (or type).

The financial transaction processing method 100 is shown in FIG. 1A as routing the received financial transaction information to a selected payment device associated with the user, at 120. In selected embodiments, the selected payment device can be selected from among the credit cards, debit cards and other types of physical and/or digital payment devices associated with the user. Stated somewhat differently, the financial transaction processing method 100 can automatically route authorizations to different underlying payment methods through an aggregating payment method based on authorization details and user preferences. Thereby, the financial transaction processing method 100 advantageously can enable the user to use a single aggregating payment method for purchases and create underlying payment authorizations corresponding to the payment authorizations on the top-level aggregating payment method.

An alternative embodiment of the financial transaction processing method 100 is illustrated in FIG. 1B. Turning to FIG. 1B, the financial transaction processing method 100 is shown as including, at 110, receiving financial transaction information (not shown). In selected embodiments, the financial transaction information can be received in the manner set forth with regard to the receiving financial transaction information at 110, as discussed above with reference to FIG. 1A. The received financial transaction information, for example, can comprise any conventional type of financial transaction information, such as information related to a new purchase, a new purchase authorization or other type of financial transaction.

The financial transaction processing method 100 can include, at 115, confirming one or more financial transaction attributes associated with the received financial transaction information. In selected embodiments, the financial transaction attributes can include any attribute associated with the financial transaction, the user and/or the selected payment device, without limitation. The financial transaction attributes, for instance, can include the user information, the payment device features and/or the vendor information discussed above with reference to FIG. 1A.

Exemplary financial transaction attributes can include, but are not limited to, a geographic location of the user, a time of day when the user typically initiates financial transactions, a financial transaction history of the user, an interest rate associated with the payment device, available credit limit associated with the payment device, a rewards program associated with the payment device, a merchant category code of the vendor, a location of the vendor, a presence (online vs. offline) of the vendor, whether the user has engaged in prior financial transactions with the vendor. In selected embodiments, the one or more financial transaction attributes associated with the received financial transaction information can be confirmed in real time.

The financial transaction processing method 100 is shown in FIG. 1B as routing the confirmed financial transaction information to a selected payment device associated with the user, at 122. In selected embodiments, the selected payment device can be selected from among the credit cards, debit cards and other types of physical and/or digital payment devices associated with the user. Stated somewhat differently, the financial transaction processing method 100 can automatically route authorizations to different underlying payment methods through an aggregating payment method based on authorization details and user preferences. Thereby, the financial transaction processing method 100 advantageously can enable the user to use a single aggregating payment method for purchases and create underlying payment authorizations corresponding to the payment authorizations on the top-level aggregating payment method.

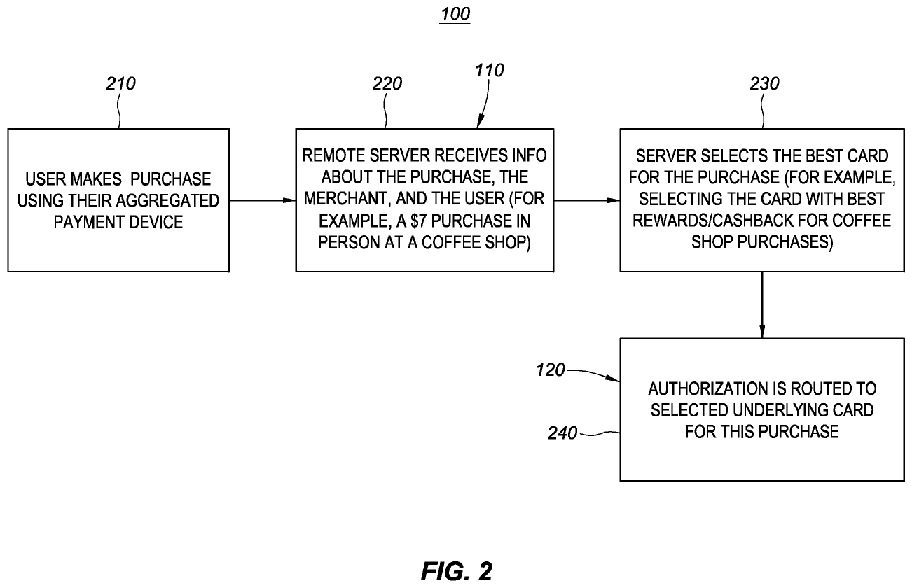

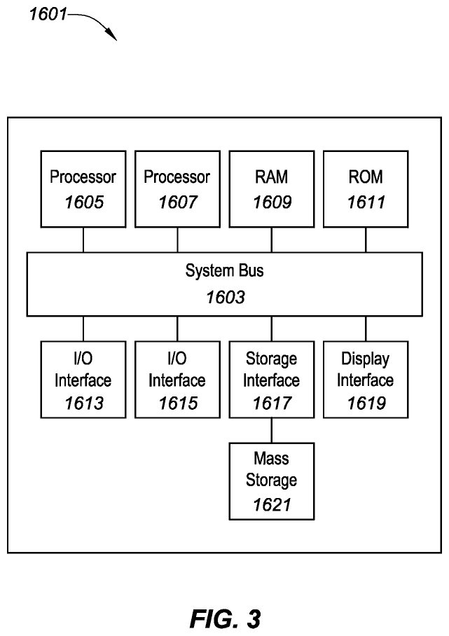

Another alternative embodiment of the financial transaction processing method 100 is illustrated in FIG. 2. Turning to FIG. 2, the user can initiate a purchase or other financial transaction, at 210, via an aggregated payment device. Information about the initiated financial transaction can be received at 220. In selected embodiments, the financial transaction information can be received at a processing system (or circuit), such as a computer system 1601 (shown in FIG. 3). The processing system can be proximal to and/or distal from the user and/or the vendor for attending to or otherwise fulfilling the financial transaction. In the manner discussed above with reference to the financial transaction processing method 100 of FIGS. 1A-B, the received financial transaction information can include, but is not limited to, any suitable grouping and/or combination of one or more payment device features of the payment devices associated with the user initiating the financial transaction, the information about the financial transaction, the information about the user and/or the information about at least one vendor for fulfilling the financial transaction.

At 230, the processing system can select a payment device associated with the user for consummating the financial transaction. The selected payment device preferably comprises a best or otherwise optimal payment device associated with the user for consummating the financial transaction based upon an evaluation of the received financial transaction information. The selected payment device, for instance, comprise the payment device with the best rewards, cash back or other incentive based upon the received financial transaction information.

Selection of the optimal payment device can be illustrated by the following example. In this example, a selected user can be associated with three payment devices with respective rewards programs. A first payment device can comprise a credit card and can be associated with a rewards program that offers 4× points on restaurant purchases, 2× points at bars, and 1× points on all other purchases with each of these points being worth 0.9 cents. A second payment device also can comprise a credit card and can be associated with a rewards program that offers 4% cash back on restaurant purchases, 2% cash back on online shopping, and 1% cash back on all other purchases. Whereas, a third payment device can comprise a debit card and can be associated with a rewards program that offers no cash back, points or other rewards.

In one evening, this user can dine at a restaurant, withdraw cash from an automated teller machine (or ATM), visit a bar and make an online purchase from a website. When the user initiates a first financial transaction to pay for dinner at the restaurant, the financial transaction processing method 100 advantageously can consider the respective rewards programs of the three payment devices and can identify one or more of the payment devices as being candidates for the first financial transaction. The financial transaction processing method 100 thereby can identify the second payment device as being a first choice for the first financial transaction.

The second payment device is identified because, for the first financial transaction, the rewards value for the second payment device is greater than the rewards value for the first or third payment devices. Although the first payment device offers 4× points for the first financial transaction, the ultimate value of these points will be weighted lower than the points for the second payment device because each point is worth 0.9 cents. As a result, the estimated cash value of these rewards 3.6% cash back for the first payment device compared to the 4% cash back for the second payment device. As set forth above, the third payment device offers no cash back, points or other rewards and thus will be ranked as a third choice.

In selected embodiments, the financial transaction processing method 100 can identify the first payment device as being a second choice the first financial transaction, for instance, in case the first payment device is declined. The financial transaction processing method 100 optionally can identify the third payment device as being a third choice the first financial transaction, for instance, in case the first and second payment devices are declined.

When the user initiates a second financial transaction by withdrawing cash from the ATM, the financial transaction processing method 100 can further consider the three payment devices and can identify one or more of the payment devices as being candidates for the second financial transaction. The financial transaction processing method 100 can identify the third payment device as a first choice for the second financial transaction. As set forth above, the third payment device is a debit card and thus is the most appropriate payment device for withdrawing cash from the ATM. The third payment device optionally can be identified as the only choice for the second financial transaction. Additionally and/or alternatively, the financial transaction processing method 100 can identify the first or second payment device as a second choice (and/or a third choice) for the second financial transaction in the manner set forth above with regard to the first financial transaction.

When the user initiates a third financial transaction by paying for libations at the bar, the financial transaction processing method 100 can consider the respective rewards programs of the three payment devices and can identify one or more of the payment devices as being candidates for the third financial transaction. The financial transaction processing method 100 thereby can identify the first payment device as being a first choice for the third financial transaction. The rewards program associated with the first payment device offers 2× points for transactions at bars.

The second payment device can be identified as a second choice for the third financial transaction because the associated rewards program offers 1% cash back on transactions at bars; whereas, the third payment device offers no cash back, points or other rewards and thus will be ranked as a third choice. The financial transaction processing method 100 thus can determine that the first payment device offers the highest available reward among the three payment devices. Additionally and/or alternatively, the financial transaction processing method 100 can identify the second or third payment device as a second choice (and/or a third choice) for the third financial transaction in the manner set forth above with regard to the first financial transaction.

When the user initiates a fourth financial transaction by initiating the online purchase, the financial transaction processing method 100 can consider the respective rewards programs of the three payment devices and can identify one or more of the payment devices as being candidates for the fourth financial transaction. The financial transaction processing method 100 thereby can identify the second payment device as being a first choice for the fourth financial transaction. The rewards program associated with the second payment device offers 2% cash back for online transactions.

The financial transaction processing method 100 thereby can identify the first payment device as a second choice for the fourth financial transaction because the associated rewards program offers 1× points for online purchases; whereas, the third payment device offers no cash back, points or other rewards and thus will be ranked as a third choice. The financial transaction processing method 100 thus can determine that the second payment device offers the highest available reward among the three payment devices. Additionally and/or alternatively, the financial transaction processing method 100 can identify the first or third payment device as a second choice (and/or a third choice) for the fourth financial transaction in the manner set forth above with regard to the first financial transaction.

A second example can illustrate an alternative exemplary manner by which the financial transaction processing method 100 can select an optimal payment device to which a selected transaction can be routed. In this second example, a first user can be associated with one or more first payment devices of the first user as well as one or more second payment devices of a second user. The first user can initiate a selected financial transaction in accordance with a user agreement with the second user that a payment or other cost of the selected financial transaction will be split or otherwise divided between the first and second users. The first and second users, for instance, can be travelling together and agree to divide the travel expenses in a predetermined manner. The first and second users can agree to allocate a certain percentage (or amount) of the cost of the selected financial transaction to each of the users, such as an equal allocation of the cost.

The financial transaction processing method 100 advantageously can allocate a first portion of the cost of the selected financial transaction to the first user and a second (or remaining) portion of the cost of the selected financial transaction to the second user pursuant to the user agreement. In selected embodiments, the financial transaction processing method 100 can select of an optimal first payment device from among the first payment devices of the first user for the first portion of the cost of the selected financial transaction. The financial transaction processing method 100, for instance, can select of the optimal first payment device in the manner set forth above and route the first portion of the cost of the selected financial transaction to the optimal first payment device.

Additionally and/or alternatively, the financial transaction processing method 100 can select of an optimal second payment device from among the second payment devices of the second user for the second portion of the cost of the selected financial transaction. The financial transaction processing method 100, for instance, can select of the optimal second payment device in the manner set forth above and route the second portion of the cost of the selected financial transaction to the optimal second payment device. Advantageously, the financial transaction processing method 100 can automatically select of the optimal first and second payment devices and route the first and second portions of the cost of the selected financial transaction to the respective optimal first and second payment devices in contrast to conventional methods that require the first user to pay the entire cost of the selected financial transaction and later seek reimbursement from the second user.

Although described with reference to first and second users for purposes of illustration only, this second example can extend to any predetermined number of users. In other words, the first user can be associated with one or more first payment devices of the first user, a second payment device of a second user, a third payment device of a third user, and so on. The financial transaction processing method 100 thereby can advantageously select an optimal payment device for each of the plurality of users to which the selected transaction can be routed.

In selected embodiments, the financial transaction processing method 100 can generate or otherwise utilize one or more rules for evaluating the received financial transaction information and selecting the selected payment device for consummating the financial transaction. Stated somewhat differently, the financial transaction processing method 100 identify the selected payment device can be governed by one or more rules that can be preset by the financial transaction processing method 100 and/or provided by the user. Funds thereby can be drawn from the selected payment device for the financial transaction.

Exemplary preset rules can include, but are not limited to, a first rule for presetting a specific payment device or other payment method to be used for specific types of financial transactions, a second rule for presetting a specific payment device or other payment method to be used for a specific setting, a third rule for presetting a specific payment device or other payment method to be used for a specific vendor, a fourth rule for presetting a specific payment device or other payment method to be used for financial transactions with a transaction amount that is greater than a first predetermined financial transaction amount, and/or a fifth rule for presetting a specific payment device or other payment method to be used for financial transactions with a transaction amount that is less than a second predetermined financial transaction amount.

For instance, the first rule could preset a selected payment device for use with all financial transactions associated with restaurants. The second rule could preset a selected payment device for use with all financial transactions involving online purchases. Additionally and/or alternatively, the third rule could preset a selected payment device for use with all financial transactions with a selected vendor. The fourth rule could preset a selected payment device for use with all financial transactions with a transaction amount that is greater than $500.

Additionally and/or alternatively, the financial transaction processing method 100 can generate at least one of the rules at a time of the financial transaction, such as when the financial transaction is initiated, and/or based on at least one attribute or other information about the financial transaction. An exemplary rule that can be generated at the time of the financial transaction can include ranking the available payment devices associated with the user for a selected financial transaction based on estimated monetary values of the rewards offered by the available payment devices for the selected financial transaction.

If the financial transaction involves a purchase at a restaurant, for instance, the financial transaction processing method 100 can rank the available payment devices in order of a first payment device with the highest value rewards for restaurant transactions, a second payment device with the second highest value rewards for restaurant transactions, a third payment device with the third highest value rewards for restaurant transactions, and so on. The financial transaction processing method 100 can select the first payment device with the highest rank for the restaurant transaction. If the first payment device is declined, the financial transaction processing method 100 can select the second payment device with the second highest rank for the restaurant transaction and the third payment device with the third highest rank for the restaurant transaction if both the first and second payment devices are declined.

In selected embodiments of the exemplary rule, the financial transaction processing method 100 optionally can dynamically rank the available payment devices. The available payment devices, for example, can be dynamically ranked depending on a transaction amount of the financial transaction. For a financial transaction with a transaction amount that is greater than (and/or equal to) a predetermined transaction amount threshold, one or more of the payment devices can be excluded from the ranking of the available payment devices. The financial transaction processing method 100 can exclude a payment device, for example, if the payment device has an available credit limit or other funding limit that is less than the transaction amount of the financial transaction. An excluded payment device can be excluded from the payment device ranking for the financial transaction even if the rewards program associated with the excluded payment device is more beneficial than the rewards programs of the ranked payment devices.

As shown in FIG. 2, authorization for the financial transaction can be provided or otherwise routed to the selected payment device, at 240. In selected embodiments the authorization for the financial transaction can be routed to the selected payment device automatically. This automatic routing could be embodied to route each charge to the best underlying payment method according to the best cash back/points/merchant rewards for the purchase or other financial transaction. Additionally and/or alternatively, the financial transaction can be routed to the underlying payment method based upon a price amount of the financial transaction. For example, the financial transaction can be routed to a payment device with sufficient credit and/or funding for the size and/or amount of the financial transaction.

In selected embodiments, the financial transaction processing method 100 can enable the user to establish the routing of the authorization for one or more financial transactions to the selected payment device. Stated somewhat differently, the user can manually set the routing of the authorization for selected financial transactions to the selected payment device. The routing of the selected financial transactions, for example, can be set based upon one more personal choices and/or personal preferences of the user.

According to various embodiments, various functionality of the financial transaction processing method 100 discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 3 is an example computer employable in various embodiments of the present disclosure. Exemplary computer 1601 includes system bus 1603 which operatively connects two processors 1605 and 1607, random access memory (RAM) 1609, read-only memory (ROM) 1611, input and/or output (I/O) interfaces 1613 and 1615, storage interface 1617, and display interface 1619.

Storage interface 1617 in turn connects to mass storage 1621. Each of I/O interfaces 1613 and 1615 can, as just some examples, be a Universal Serial Bus (USB), a Thunderbolt, an Ethernet, a Bluetooth, a Long Term Evolution (LTE), a 5G, an IEEE 488, and/or other interface. Mass storage 1621 can be a flash drive, a hard drive, an optical drive, or a memory chip, as just some possibilities. Processors 1605 and 1607 can each be, as just some examples, a commonly known processor such as an ARM-based or x86-based processor.

Computer 1601 can, in various embodiments, include or be connected to a touch screen, a mouse, and/or a keyboard. Computer 1601 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present disclosure, a computer may run one or more software modules designed to perform one or more of the above-described operations. Such modules can, for example, be programmed using Python, Java, JavaScript, Swift, React, C, C++, C#, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed.

Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed.

It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

In selected embodiments, one or more of the features disclosed herein can be provided as a computer program product. The computer program product, for example, can be encoded on one or more non-transitory machine-readable storage media, such as magnetic, optical and/or electronic storage media of any kind and without limitation. As used herein, a phrase in the form of at least one of A, B, C and D herein is to be construed as meaning one or more of A, one or more of B, one or more of C and/or one or more of D.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented method for aggregating financial transactions among a plurality of first payment devices having respective first payment device attributes and being associated with a first payment device user, comprising:
receiving financial transaction information for a financial transaction at a processing circuit;
ranking the first payment devices based upon the received transaction information and the first payment device attributes via the processing circuit;
selecting one of the first payment devices with a highest ranking via the processing circuit; and
routing the financial transaction to the selected first payment device for consummation via the processing circuit.

2. The method of claim 1, further comprising:
receiving a declination indication of the selected first payment device for the financial transaction at the processing circuit; and
based upon said receiving the declination indication,
selecting a different one of the first payment devices with a second-highest ranking via the processing circuit; and
routing the financial transaction to the selected different first payment device for consummation via the processing circuit.

3. The method of claim 1, wherein said ranking the first payment devices includes comparing a total transaction amount of the financial transaction with respective first credit limits associated with the first payment devices and excluding each first payment device with a first credit limit that is less than the total transaction amount.

4. The method of claim 1, further comprising aggregating the financial transaction among the plurality of first payment devices and a plurality of second payment devices having respective second payment device attributes and being associated with a second payment device user.

5. The method of claim 4, wherein said aggregating the financial transaction includes:
ranking the second payment devices based upon the received transaction information and the second payment device attributes via the processing circuit; and
selecting one of the second payment devices with a highest ranking via the processing circuit,
wherein said routing the financial transaction comprises routing a first portion of the financial transaction to the selected first payment device and routing a second portion of the financial transaction to the selected second payment device.

6. The method of claim 5,
wherein said routing the first portion of the financial transaction comprises paying a first transaction amount of the financial transaction via the selected first payment device, and
wherein said routing the second portion of the financial transaction comprises paying a reminder of a total transaction amount of the financial transaction via the selected second payment device.

7. The method of claim 5, wherein said routing the first portion of the financial transaction and said routing the second portion of the financial transaction are performed pursuant to an agreement between the first payment device user and the second payment device user to divide a total transaction amount of the financial transaction in a predetermined manner.

8. The method of claim 5,
wherein the second payment devices are associated with the first payment device user; and
wherein said routing the second portion of the financial transaction are performed pursuant to authorization provided by the first payment device user.

9. The method of claim 1, wherein said ranking the first payment devices is based upon one or more rules for evaluating the received transaction information.

10. The method of claim 9, wherein said rules include a first rule for designating a first specific first payment device for a specific financial transaction type, a second rule for designating a second specific first payment device for a specific financial transaction setting, a third rule for designating a third specific first payment device for a specific vendor, a fourth rule for designating a fourth specific first payment device for financial transactions with a total transaction amount that is greater than a first predetermined financial transaction amount, a fifth rule for designating a fifth specific first payment device for financial transactions with a total transaction amount that is less than a second predetermined financial transaction amount, or a combination thereof.

11. The method of claim 10, further comprising enabling the first payment device user to designate at least one of the rules for evaluating the received transaction information.

12. The method of claim 10, further comprising generating the one or more rules at a time of initiating the financial transaction.

13. The method of claim 1,
wherein said receiving the financial transaction information comprises receiving first geographical information for the first payment device user and second geographical information for a vendor for fulfilling the financial transaction, the first geographical information and the second geographical information being associated with different countries, and
wherein said ranking the first payment devices includes ranking the first payment devices based upon a first foreign exchange fee of the of first payment devices.

14. The method of claim 1, wherein said ranking the first payment devices includes ranking the first payment devices based upon the received transaction information and rewards programs respectively associated with the first payment devices.

15. The method of claim 1, wherein said receiving the financial transaction information comprising receiving the financial transaction information for the financial transaction in real time.

16. The method of claim 15, wherein said ranking the first payment devices includes dynamically ranking the first payment devices based upon the first payment device attributes and the financial transaction information received in real time.

17. The method of claim 1, wherein said ranking the first payment devices includes comparing the financial transaction information with a plurality of first payment device attributes for each of the first payment devices.

18. The method of claim 1, wherein said selecting the one of the first payment devices comprises selecting a physical credit card, a virtual credit card, a physical debit card, a virtual debit card, a physical payment card, a virtual payment card, cryptocurrency or a bank account.

19. A computer program product for aggregating financial transactions among a plurality of first payment devices having respective first payment device attributes and being associated with a first payment device user, the computer program product being encoded on one or more non-transitory machine-readable storage media and comprising:
instruction for ranking the first payment devices based upon the first payment device attributes and financial transaction information associated with a financial transaction;
instruction for selecting one of the first payment devices with a highest ranking via the processing circuit; and
instruction routing the financial transaction to the selected first payment device for consummation via the processing circuit.

20. A system for aggregating financial transactions among a plurality of first payment devices having respective first payment device attributes and being associated with a first payment device user, comprising:
at least one processing circuit being configured for ranking the first payment devices based upon the first payment device attributes and financial transaction information including a transaction amount associated with a financial transaction, selecting one of the first payment devices with a highest ranking via the processing circuit and routing the financial transaction to the selected first payment device for consummation via the processing circuit,
wherein the transaction amount is paid via funds drawing from the selected first payment device.
